(19) United States
(12) Patent Application Publication
(10) Pub. No.: US 2005/0189880 A1
(43) Pub. Date: Sep. 1, 2005

(54) Gas-slip prepared reduced surface defect optical photoconductor aluminum alloy tube

(75) Inventors: Laurie Russell, Virginia Beach, VA (US); Mamoru Nozomi, Virginia Beach, VA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI CHEMICAL AMERICA. INC., Chesapeake, VA (US)

(21) Appl. No.: 10/788,442

(22) Filed: Mar. 1, 2004

(51) Int. Cl. G03G 5/10; B21F 1/00

(52) U.S. Cl. 315/1; 430/69; 428/586

(57) ABSTRACT

Optical electrophotoconductor drums and electrophotoconductive tubes obtained via a direct chill metal casting apparatus for continuous or semi-continuous casting of metal (DC casting). In particular, casting of ingots of aluminum which provide the electrophotoconductive tubes that are subsequently coated to produce drums for copier and printers is presented. A gas-slip prepared surface of the tube results in a reduced and limited size and number of defects of an aluminum alloy material wherein the defects arise from a casting, subsequent extrusion, and subsequent drawing process. The defects arise primarily from either feather line lamination defects or from weld-line defects where the lamination defects are characterized by at least a slightly rougher surface and often a different chemical composition than that of the aluminum alloy at one point in the feather line lamination and where the weld-line defects occur in the extrusion process from contaminants present in either an aluminum casted ingot or log. Preparation of the special surface for the subsequently coated optical photoconductive drum results in increased yield, higher quality and lower manufacturing costs.

### BACKGROUND OF THE INVENTION

1. Field of the Invention

The invention relates to an electrophotoconductive tube prepared by a process that includes gas-slip casting of an aluminum alloy using an apparatus for continuous or semi-continuous direct chill casting of metal. The invention includes an optical photoconductor drum which comprises a charge transport layer and a charge generation layer coated onto the electrophotoconductive tube and the use of the optical photoconductor drum for photocopying.

2. Description of the Related Art

Photoreceptors are the central device in photocopiers and laser beam printers. In most photocopiers and laser beam printers, the photoreceptor surface is contained on the outside of a hollow metal cylinder called a tube (e.g., an electrophotoconductive tube; the term electrophotoconductive tube is used herein to identify a metal tube that is used as the substrate for forming an optical photoconductor drum by coating the tube with a charge generation layer and a charge transport layer). Typically, the tube is made of a metal, such as aluminum, which may be anodized, diamond turned and then optionally coated with a thin dielectric layer (injection barrier) which is then coated with photogeneration (i.e., charge generation layer) and photoconduction layers (i.e., charge transport layer) to form an optical photoconductor drum (the term optical photoconductor drum is used herein to identify an electrophotoconductive tube that has been coated with photogeneration and photoconduction layers).

A general discussion of electrophotography (photocopying) is given in Kirk-Othmer, Encyclopedia for Chemical Technology, 4th ed., vol. 9, pp. 245-277, Wiley, New York (1994), and a brief description of laser beam printing is provided in Encyclopedia of Electronics, 2nd ed., Gibilisco et al., Eds. pp. 669-671, TAB BOOKS, Blue Ridge Summit, Pa. (1990), both of which are incorporated herein by reference.

Presently, the most suitable photoconductive imaging receptors for low and medium speed electrographic plain-paper copiers and higher speed laser printers have a double-layered configuration. Photogeneration of charge carriers (electron-hole pairs) takes place in a thin charge generation layer (CGL) typically 0.1-2.0 μm thick, which is coated on a conductive substrate such as an aluminum alloy tube. After photogeneration, mobile carriers (usually holes) are injected into a thicker charge transport layer (CTL), which is about 10-40 μm thick and coated on top of the CGL, under an electric field gradient provided by a negative surface charge. These holes drift to the outermost layer of the photoreceptor to selectively neutralize surface charge, thereby forming a latent electrostatic image, which is subsequently developed by a thermoplastic toner.

The photogeneration and photoconduction layers may be coated onto a conductive substrate such as a metal tube (e.g., the electrophotoconductive tube). The metal tube may be hollow to provide advantages of weight and a reduction in material cost. The external surface of the metal tube may exert a significant influence the quality of any optical photoconductor drum derived therefrom. A metal tube having an irregular surface or a surface exhibiting, for example, non-uniform conductivity may provide a defective electrophotoconductive tube.

Aluminum which has good casting properties and desirable physical properties such as low density may be used to form a portion of or the entire metal tube. The quality and yield in producing optical photoconductor drums from aluminum tubes is based primarily on the surface properties of the aluminum tube prior to the application of any of the photogeneration and photoconduction layers. Coated tubes are very costly to discard and very difficult, if not impossible, to reclaim.

The grain structure of a metal or an alloy affects a number of important properties in the product. Grain refining of aluminum and aluminum based alloys is an example of how a structure consisting of small equiaxial grains gives a number of advantages compared to a structure comprising larger grains structure. Important properties include improved castability due to more efficient flow of metal; improved mechanical properties; improved machinability; and improved surface quality.

The grain size may vary with the chemical composition of the alloy and with the casting method used to form a part. The casting method decides a number of important factors, such as cooling rate, casting temperature, temperature gradient and the state of mixture in the melt both before and during solidification.

There remains a need for improved “substrate” or tube surface properties so that the number or percentage of coated tubes (e.g., optical photoconductor drums) that must be discarded based on defects created by imperfections in the surface of the pre-coated tubes can be eliminated or at least substantially minimized. The invention electrophotoconductive tube addresses this need by providing an improved surface finish on metal tubes through the casting technique used to prepare the tube and the composition of the aluminum alloy from which the tube is derived.

### OBJECTS OF THE INVENTION

Accordingly, it is an object of the present invention is to provide an electrophotoconductive tube prepared by a gas-slip casting apparatus for continuous or semi-continuous direct chill casting of metal (DC casting).

Another object of the invention is to provide an optical photoconductor drum prepared from an electrophotoconductive tube prepared by gas-slip casting of certain alloys that may contain grain-refining additives.

Another object of the present invention is to provide an electrophotoconductive tube having improved grain refinement prepared by a gas-slip hot-top mold system for multi-strand billet casting where the aluminum contains titanium boride (TiB₂) or other similar additives to control grain growth and uniformity in both the casting operation and the homogenization process.

It is a further object of the invention to use recycled aluminum such as from scrap or regrind of defective aluminum billets in gas-slip casting to prepare electrophotoconductive tubes and optical photoconductor drums.

### SUMMARY OF THE INVENTION

One embodiment of the invention is an electrophotoconductive tube prepared by a gas-slip process. The invention electrophotoconductive tube has special surface properties that permit its use in forming an optical photoconductor drum.

Another embodiment of the invention is an optical photoconductor drum prepared by applying one or more optical coatings onto the external surface of electrophotoconductive tube to form an optical photoconductor drum having improved surface properties and a lower defect rate in comparison to optical photoconductor drums prepared from electrophotoconductive tubes derived from conventional casting processes. The use of electrophotoconductive tubes prepared by the gas-slip process substantially reduces and in some cases eliminates defects on the surface of the optical photoconductor drum after the electrophotoconductive tube has been coated with photogeneration and photoconduction layers. The electrophotoconductive tubes obtained by the gas-slip process have surface characteristics that eliminate the necessity for filtering of the aluminum alloy during casting. Inclusion of additives in the aluminum alloy provides further improvements in surface grain and a further lowering of the defect rate.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic of a conventional hot-top cast process;

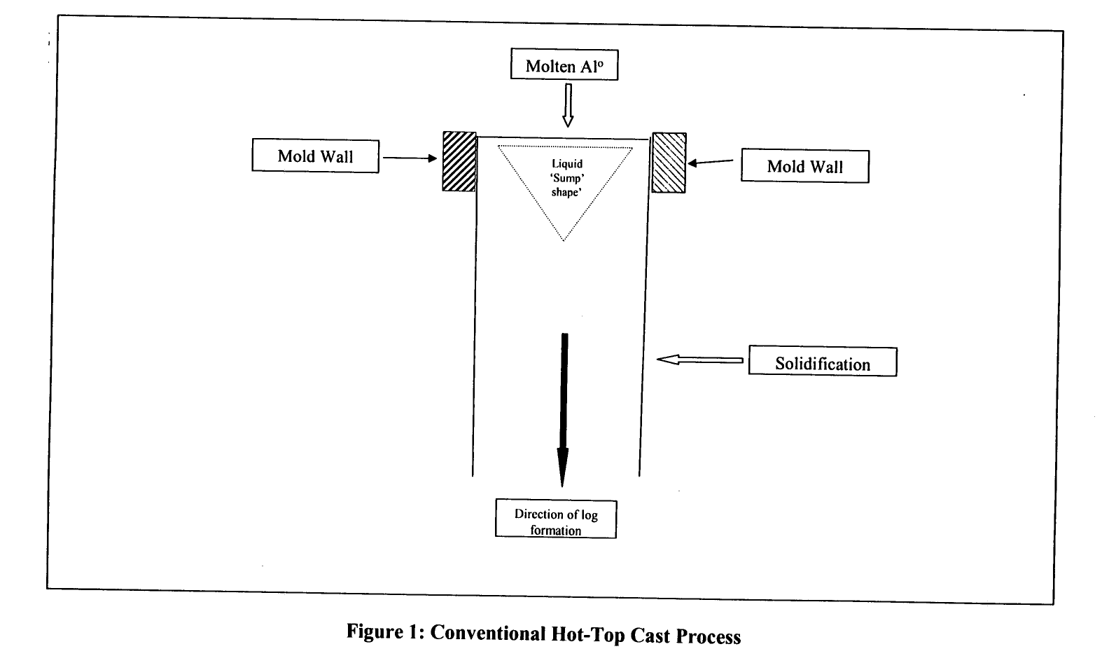

FIG. 2 is a schematic of a gas-slip process;

FIG. 3 is a view of a conventional hot-top cast table;

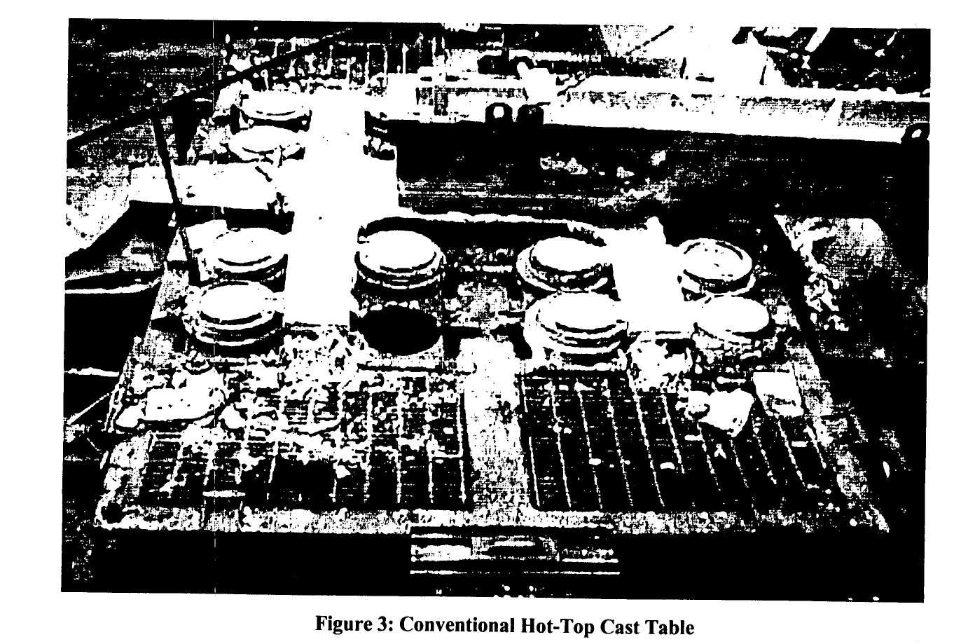

FIG. 4 is an enlarged view of a portion of a gas-slip cast table used in manufacture of the present invention;

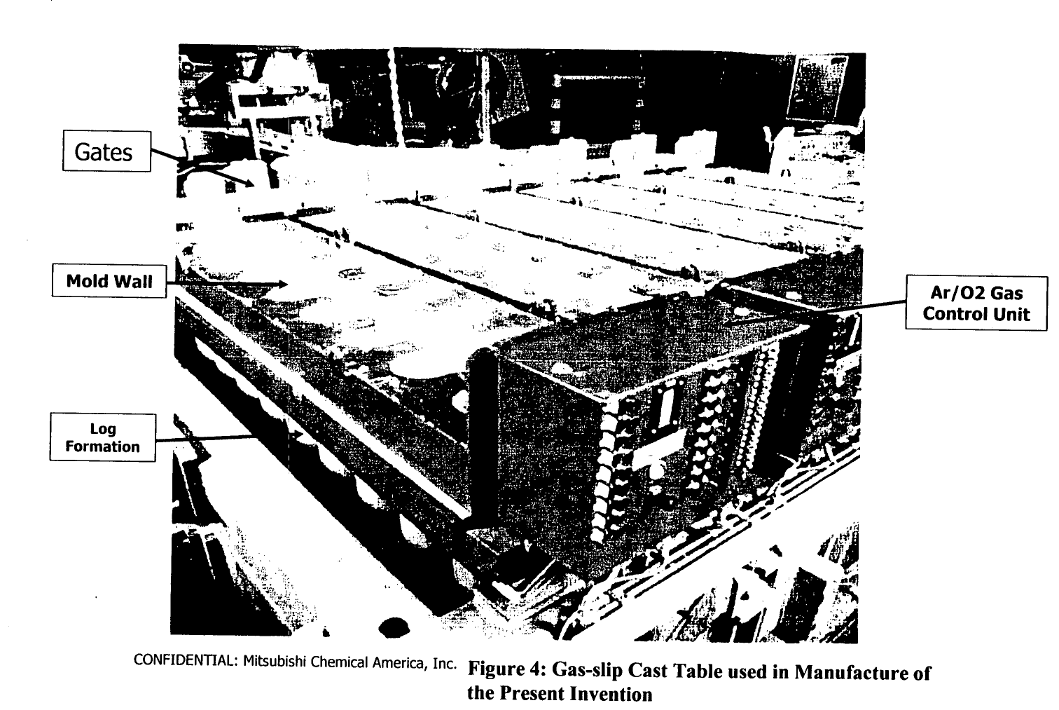

FIG. 5 is a comparison of the surface finishes for drawn tube aluminum alloys obtained for both gas-slip and conventional tube products;

FIG. 6 is a comparison of a optical weld-line analysis for aluminum alloys of both the gas-slip and conventional tube products;

FIG. 7 is a comparison of turned surface finishes for aluminum alloys of both gas-slip and conventional tube products;

FIG. 8 is a comparison of surface finish of a gas-slip unfiltered aluminum alloys with an aluminum alloy of a TKR filtered conventional product;

FIG. 9 is a comparison of typical lamination defects for both gas-slip and conventional products.

### DETAILED DESCRIPTION OF THE INVENTION

The electrophotoconductive tubes of the invention may be prepared using a casting apparatus for continuous or semi-continuous direct chill casting (DC casting) of metal. A billet is formed upon casting of an aluminum alloy, for example in seamless or porthole casting. The billet may subsequently be drawn and/or extruded to narrow the tube. The extruded/drawn tube is then cut to size for coating.

The invention electrophotoconductive tube may be prepared from DC casting equipment of the type which is at least as simple as, or more simple, than conventional casting equipment but which provides considerably greater flexibility with regard to regulation of the cooling effect and whereby it is possible to differ or vary the cooling effect around the passage through the casting die by means of sectional control of the rate of cooling. The gas-slip process allows optimal cooling conditions to be obtained, for example, in the corners and on the short sides of the casted tube where many problems may otherwise arise during the start phase of conventional casting processes.

Reduced cooling during the start phase of DC casting of metal results in positive effects with regard to shrinkage, start cracks and surface quality. The reduced cooling may also have a positive effect with respect to other problems associated with casting large billets. Large billets may form the basis and are the precursor for the photoconductive tubes of the present invention.

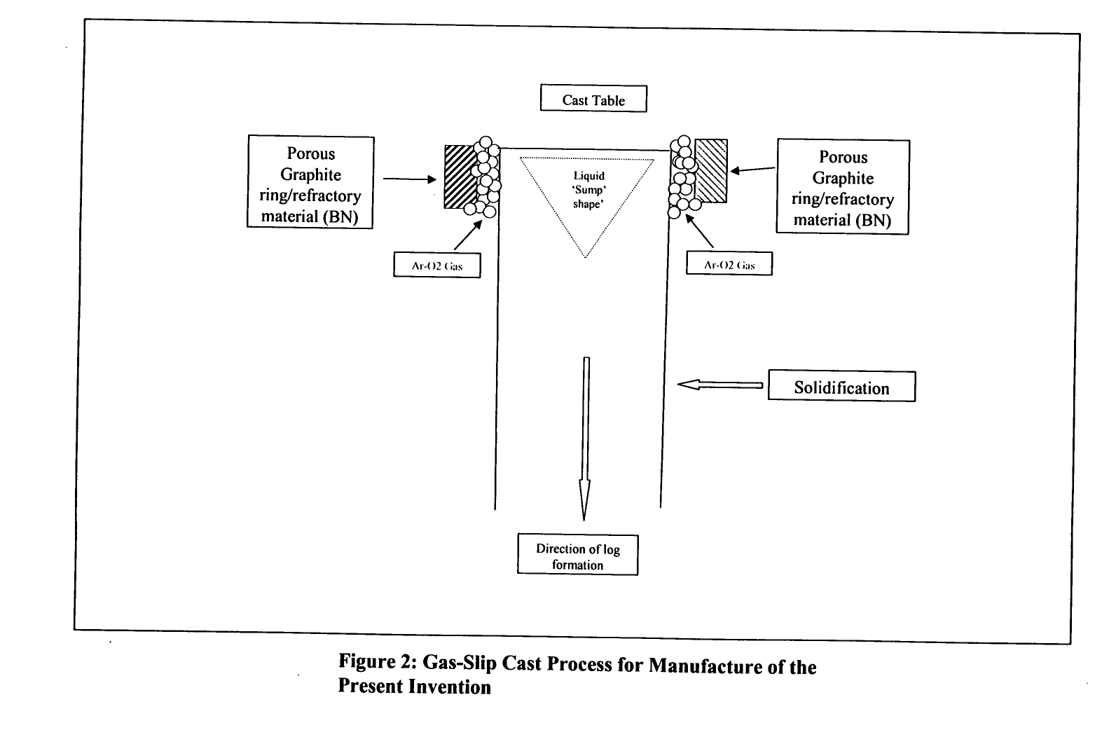

The gas-slip process of the invention is shown in FIG. 2. The gas-slip process of the invention may be carried out with a DC apparatus wherein between the water outlet and predominantly in parallel with it along the circumference of the opening formed by the casting die, a further outlet, row of holes or a similar arrangement (such as a porous graphite ring) is provided for supplying gas, such as air, so that a skirt of gas is formed along the outer periphery of a billet. The gas is provided to deflect a skirt of a cooling fluid, such as water, and/or form an air cushion between the skirt of water and the billet.

In conventional casting the aluminum alloy is in contact with a die which may be used to direct the flow of molten aluminum alloy and thereby form the desired shape. Gas-slip casting on the other hand avoids direct contact of the aluminum at the point where the aluminum is cast to form the desired shape. Instead, in gas-slip casting a gas cushion protects the billet as the molten aluminum takes shape. The gas cushion is preferably a mixture of argon and oxygen. In this manner the billet is subjected to less and possibly no contact with a die. While not limiting the invention to any particular theory it is thought that by avoiding contacting the solidifying aluminum with the surface of the die, the billet is subject to less abrasion and hence provides a smoother and more regular surface. It is possible that filtering of the molten aluminum alloy, as performed in conventional hot-top casting processes, may be significantly reduced or even eliminated with the gas-slip process.

Table 1 below characterizes the major differences between conventional casting processes used for producing photoconductive tubes that are subsequently dip coated to provide an optical photoconductor drum having photogeneration and photoconduction layers.

TABLE 1
Gas-Slip Casting and Conventional Hot Top Casting Methods

| | | Conventional |
|---|---|---|
| | Gas-Slip Cast | Hot Top |
| | Process | Cast Process |
| Primary Coolant | Light mineral oil at | Heavy grease at |
| | mold wall | mold wall |
| Secondary Coolant | Water spray | Water spray |
| (cool solidified log) | | |
| Cast mold wall | Gas cushion (Ar/O₂) | Metal ring/die |
| Table Design | a) 5 modules at 8 | 18 logs (9″ OD) |
| | logs/module | |
| | (40 logs/cast drop - | |
| | 9″ OD) | |
| | b) molten cast flow is | |
| | controlled by | |
| | gate system | |
| Molten cast flow | minimal turbulence | some turbulence |
| | | (higher porosity) |
| Filtration | TKR filtered alloy which | TKR filtered alloy |
| | is the highest purity | which is the |
| | alloy Hydro makes | highest purity alloy |
| | | Hydro makes |
| Cast lot drop size | 65K lbs | 30K lbs |
| (9″ log) | | |

The casting apparatus includes a casting die which has an open inlet for receiving a supply of molten metal and a cavity with an open outlet. At the outlet, means are provided for supplying water for direct cooling of the molten metal and for supplying gas or air for reducing the cooling effect of the water at least during the start phase of the casting process and preferably during other stages of the process. Gas-slip casting is described in U.S. Pat. No. 5,632,323 which is incorporated herein by reference in its entirety.

Air may be added to the water before it leaves the water outlet as described in the method disclosed in U.S. Pat. No. 4,693,298 (incorporated herein by reference in its entirety). The water and air mixture then passes along the circumference of the casting die opening. The direction of the inlet of air in relation to the water is approximately 90° so that air bubbles are produced in the water flow, i.e. the air is mechanically mixed with the water in the water flow. By replacing some of the volume of water with air, a uniform skirt of water may form with less water than is normally required to maintain a uniform skirt of water and, by means of the air, achieves an insulating effect.

The addition of air will, however, increase the speed of the water and thus also the cooling effect of a given quantity of water as the cooling water passes through the stream phase on the surface of the cast billet. Any reduction of the cooling effect of the water, caused by adding air to the cooling water before it leaves the water outlet, is therefore limited. Moreover, the solution as shown in the above patent offers no opportunities for differentiated cooling, i.e. a different level of cooling for one area in relation to another area along the casting die.

A similar method described in U.S. Pat. No. 4,166,495 (incorporated herein by reference in its entirety) where CO₂ is added to the cooling water instead of air may also be used in the gas-slip process to prepare the electrophotoconductive tube of the invention. When the water exits the water outlet in the casting die, very small bubbles of CO₂ are formed due to a pressure drop and an increase in temperature. The CO₂ bubbles form a partially insulating layer between the cast billet and the cooling water so that the overall cooling area is reduced.

This method produces roughly the same reduction of cooling effect as the first-described method, but is more expensive to use because CO₂ is used as the additive gas. Also, CO₂ requires additional pressure regulating equipment and mixing equipment in order to obtain the necessary pressure conditions for the process to work. As in the first-described method above, this method does not provide any opportunity for differentiated cooling along the casting die or regulation of the cooling effect.

A method providing reduced or aborted cooling in which air nozzles are positioned slightly below the casting die may also be used (see “Metal Progress,” No. 2 (1957), pages 70-74; incorporated herein by reference). When the cooling water flows down over the cast billet and when the water reaches the nozzles, the water is blown away from the billet so that the area of the billet below the air nozzles is not exposed to direct water cooling. Only the area of the billet above the nozzles is directly cooled by the water. This method may not reduce the cooling during the start phase of the casting process and therefore the positive effects realized regarding shrinkage and surface quality are small or insignificant.

The tube is prepared from metal stock that may include casting billets of aluminum for milling purposes. In particular, aluminum is preferably used as the metal stock for the photoconductive tube. The electrophotoconductive tube may comprise or consist of aluminum or an aluminum alloy. Typical aluminum alloys include the 3000 and 6000 series and E3S. Recycled aluminum may also be used to form a portion or all of the electrophotoconductive tube. The recycled aluminum may be from scrap or regrind from defective tubes. Aluminum 3003 alloy with titanium boride has been found effective, but other suitable alloys such as E3S that are found to be equally effective are included in this disclosure of the invention.

The invention optical photoconductor drums may be prepared by the methods and techniques known to those of skill in the art and described in, for example, U.S. Pat. Nos. 6,017,665 and 5,554,473 each of which is incorporated herein by reference in its entirety.

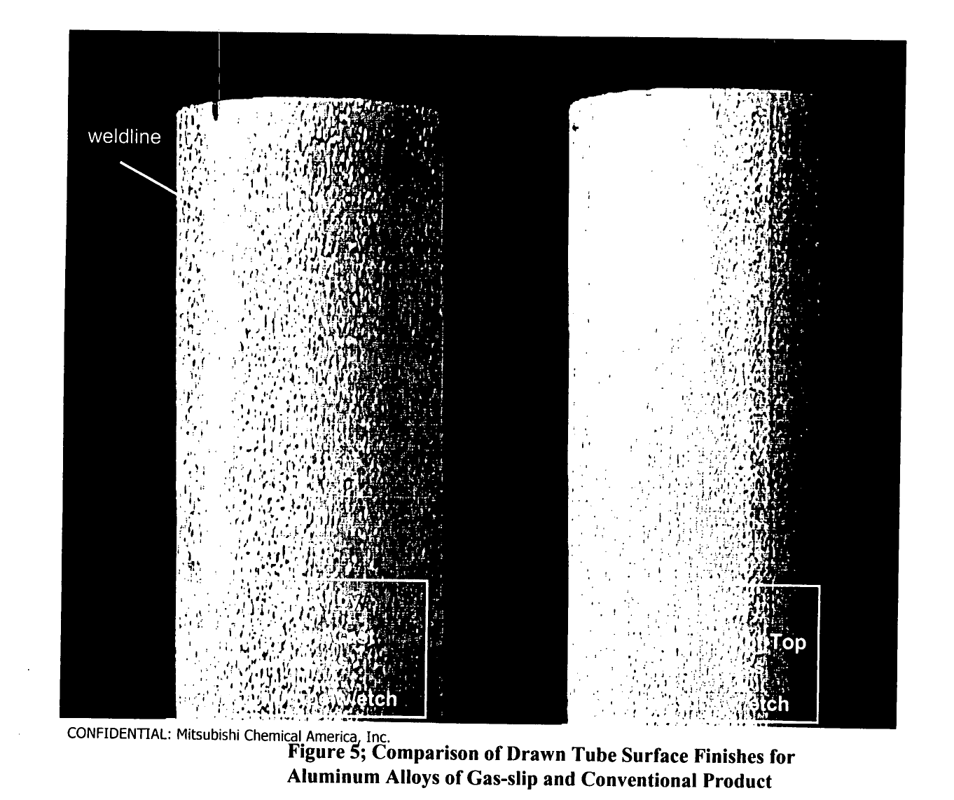

The surface properties of the electrophotoconductive tube may be improved further by including a grain refining additive in the aluminum alloy. The method and use of special additives to control optimum grain refinement in aluminum-based alloys is described in U.S. Pat. No. 6,073,677 (incorporated herein by reference in its entirety). A method of calculating the grain growth index for the composition of the alloy under consideration, and then determining how much additional grain size affecting agents, e.g. titanium and/or boron must be added to obtain desired results is detailed therein. For the present invention, the grain size may be determined from drawn or extruded tubes prior to anodization or turning. A comparison of an invention tube with a tube prepared by conventional means is shown in FIG. 5. Large grain growth during homogenization is undesirable and leads to poor yield and an increased defect rate.

Because of the improvements in surface properties obtained for the invention electrophotoconductive tubes using the gas-slip technique, the use of recycled aluminum is possible and may lead to significant cost reductions in the tube or substrate usage.

Prior to forming the optical photoconductor drums, the aluminum electrophotoconductive tubes are first drawn and/or extruded and then diamond turned or anodized. Both the turned electrophotoconductive tube and the anodized electrophotoconductive tube are a part of the invention.

The electrophotoconductive tubes of the invention are improved in comparison to electrophotoconductive tubes prepared by methods other than the invention gas-slip method described herein. Conventional casting methods for producing aluminum tubes for optical photoconductor drums may have a substrate defect rate of approximately 1% in the optical photoconductor drum (e.g., one defective optical photoconductor drum per 100 optical photoconductor drums). The defects most mentioned here are those caused by defective surface finish of the electrophotoconductive tube. In comparison, the electrophotoconductive tubes prepared by the gas-slip method of the invention may have a defect rate of less than 0.5%, preferably less than 0.4%, and even more preferably less than 0.25%. The substrate defect rate includes all defects attributable to the electrophoconductive tube including handling, material and charge transfer layer (CT Foam) defects.

The defects that may cause an optical photoconductor drum to be rejected may be detected and quantified by visual measurements. Visual measurements include inspection by the human eye or with the aid of microscopy at magnifications of from 10× to 100×. The surface that is inspected is the outer surface present on the optical photoconductor drum (i.e., an electrophotoconductive tube coated by photogeneration and photoconduction layers). Defects that may cause an optical photoconductor drum to be rejected include those defects tabulated below.

TABLE 2

| Defect Type | Typical Features | Size |
|---|---|---|
| Laminations | void or dark spot/line | μm to mm length |
| (SL, PH) | with turning line or | μm to mm diameter |
| | CT Foam | mm |
| Weld line | void or dark spot/line with | length: <1 mm to |
| (PH) | turning line or CT Foam; | entire tube length |
| | defect is on or adjacent to | |
| | the weld line | |
| Banding | wide, visual, longitudinal | length: mm |
| (PH, SL) | bands w/material lamination, | |
| | (bands may or may | |
| | not originate from weld line) | |
| Heat Streak/ | featherline: few, narrow, | featherline: mm × length |
| Featherline | long, striated streak | heat streaks: various |
| (SL, PH) | heat streaks: various | widths, shiny/dull |
| | widths, shiny/dull streaks | streaks: length of optical |
| | length of optical | photoconductor |
| | photoconductor drum | drum, ¼ to ¾ |
| | | circumference of tube |
| | with material lamination | length: mm usually |
| | | in one streak |
| Cut-Away | rough patch | 10-50 mm patch |
| (SL, PH) | | |

SL = Seamless extrusion.
PH = Porthole extrusion.

As shown in Table 2 above, defect types may include laminations, weld lines, banding, heat streaking or featherlines, and cut-aways.

Lamination defects may be from about 10 μm to several millimeters in length. It is preferable that the optical photoconductor drum not have any visible lamination defect. Weld line defects range in length from less than 1 mm to the entire length of the electrophotoconductive tube. Weld line defects are preferably not visible on the optical photoconductor drum. In some cases the weld line is substantially invisible to the naked eye. Substantially invisible means that a weld line showing a clear demarcation between areas of the surface of the optical photoconductor drum are not present or any weld line is visible along only a portion of the drum. Banding defects are preferably not visible on the optical photoconductor drum or, if visible, preferably do not traverse the entire girth of the drum. Heat streak or featherline defects are manifested in differences in color and/or striation on the surface of the drum, these defects are preferably not present on the optical photoconductor drum. If featherline or heat streak defects are present on the invention optical photoconductor drum they preferably are diffuse and do not project from the surface of the drum. Cut-away defects are characterized as rough patches on the optical photoconductor drum surface and may vary in size from 10 to 50 mm². Preferably no rough patches are visibly evident on the surface of the optical photoconductor drum. If cut-away defects are present on the surface of the optical photoconductor drum, the optical photoconductor drum is rejected as unusable.

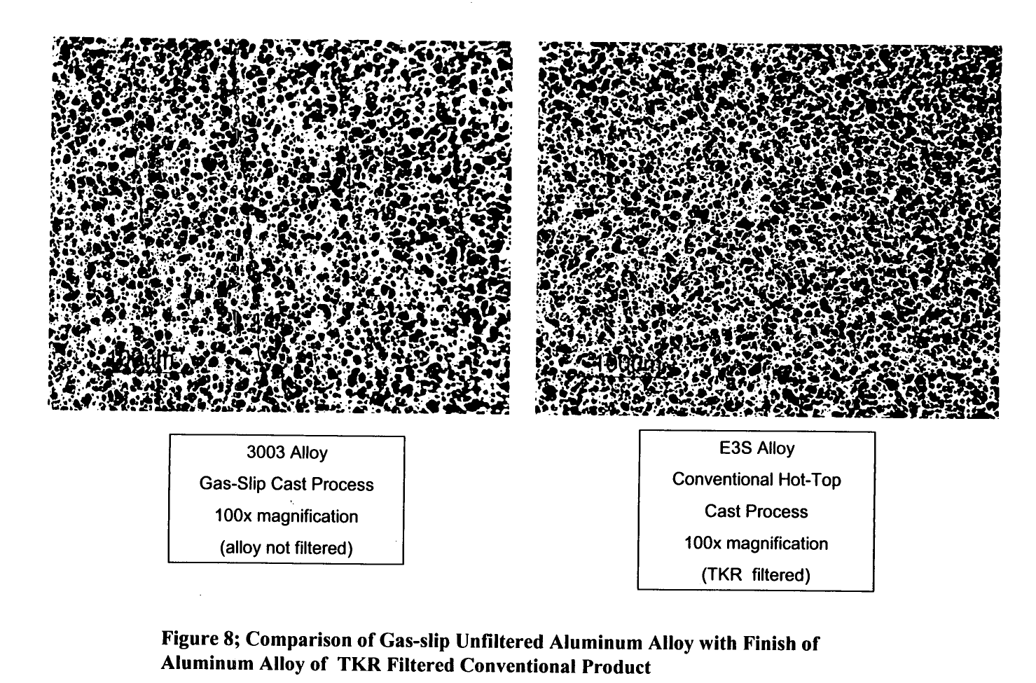

Defects that may be present on the surface of the optical photoconductor drum are related to defects present on the electrophotoconductive tube, e.g., the aluminum electrophotoconductive tube casted by the gas-slip casting process and then drawn or extruded. Grain size is an important characteristic of the surface feature of the invention electrophotoconductive tube. Grain size and structure of the electrophotoconductive tube is substantially less than the grain size and structure obtained in electrophotoconductive tubes prepared by conventional casting methods. Grain size and structure may be determined by, for example, dendrite arm spacing, billet slice test, inverse grain segregation, and intermetallic distance. FIG. 8 provides a comparison of the surface of the invention electrophotoconductive tube and a tube prepared from a conventional casting process. The difference in grain structure may be quantified by comparing the relative sizes and density of the grains of the two surfaces.

Grain size of the surface of the drawn tubes may also be measured according to the ASTM standard E112. The test method provides a determination of grain size along tangential longitudinal view, a radial longitudinal view and a transverse view.

The porosity (H₂) of the drawn tube also provides a measurement of the surface characteristics and hence is an indicator of the surface quality of the finished optical photoconductor drum. The porosity of the invention electrophotoconductive tube in ml/100 grams is preferably less than 0.2. In comparison the porosity obtainable with conventional casting methods may be greater than 0.3 ml/100 grams. Preferably the porosity of the invention electrophotoconductive tube is 0.1 ml/100 grams or less.

Inclusions in the electrophotoconductive tube also play an important role in the eventual surface quality of any optical photoconductor drum derived therefrom and the defect rate of the optical photoconductor drum. A liquid metal cleanliness analyzer (LiMCA test) for a conventionally produced electrophotoconductive tube is 0.08 (N20) or 0.014 (N30). The invention electrophotoconductive tube has improved values at both N20 and N30. Values for the invention electrophotoconductive tube may range from 0.04 or less, preferably from 0.001 to 0.03 for N20, and 0.007 or less, preferably 0.0001 to 0.004 for N30.

Inclusions may also be determined using a porous disk filtration apparatus (PODFA test of the molten alloy). Results of the PODFA test are reported in mm²/kg and are preferably less than those of conventional electrophotoconductive tubes prepared by, for example, hot-top casting.

Chemical analysis of the electrophotoconductive tubes can be carried out by optical emission spectroscopy (OES) or inductively coupled plasma analysis (ICP). The invention aluminum tube may demonstrate a substantially higher concentration of impurities and still provide surface qualities superior to those surface qualities obtained in aluminum tubes drawn from conventional casting processes. Chemical analysis of the 3000 and 6000 alloys may be carried out as described in ASTM methods B547-95 and B483-95.

Surface oxides also provide a method by which the surface qualities of the electrophotoconductive tube may be evaluated. Surface oxides present below the surface of the electrophotoconductive tube may decrease surface quality and lead to delamination or the appearance of surface features on the optical photoconductor drum.

Some advantages of the invention gas-slip process are summarized in Table 3.

TABLE 3
Advantages of Gas-Slip Casting Process

| | Advantages |
|---|---|
| Process Control | Much tighter than conventional hot-top-better |
| | process stability and product (alloy) |
| | consistency. |
| | Cast-drop rate is controlled allowing more |
| | consistent grain size |
| Process Cleanliness | Very clean from melt furnace to trough to |
| | cast table |
| | less likely to get develop solid and gas |
| | inclusions |
| Material Quality | Improved |
| Alternative Alloys | (1) Recycled aluminum; possible because of |
| | process cleanliness. |
| | (2) Less expensive alloys (MX, 3003 TKR, |
| | etc.) may be usable because of cleaner |
| | process conditions. |
| Grain Refining | Titanium boride or other additives (optional) |
| | allow more controlled grain growth during |
| | casting and/or homogenization |

### EXAMPLES

Aluminum electrophotoconductive tubes were prepared by a conventional hot top casting method and the invention gas-slip casting method. After production of the electrophotoconductive tube, the tubes were coated with photogeneration and photoconduction layers. The finished optical photoconductor drum was subjected to visual evaluation to identify defect prone optical photoconductor drums. The results obtained for the conventionally prepared aluminum electrophotoconductive tubes and the invention electrophotoconductive tubes are shown in Table 4 below.

Visual inspection of the optical photoconductor drums is carried out by first air blowing the drum to remove foreign matter. The drum is then manually inspected and visually inspected under light for defects.

TABLE 4

| | | Conventional Hot | | | |
|---|---|---|---|---|---|
| | | Top Cast Method | | Gas Slip Cast Lot | |
| Quantity | | 51597 | | 10368 | |
| Inspected | | | | | |
| Tube Size | | A4 Tube | | A4 Tube | |
| Substrate | | 0.90% | | 0.38% | |
| Defects | | | | | |
| | Root Cause | Defect | % of | Defect | % of |
| | Breakdown | Rate (%) | Substrate | Rate (%) | Substrate |
| | | | Defects | | Defects |
| | Material | 0.30% | 33% | 0.01% | 3% |
| | Process | 0.01% | 1% | 0.00% | 0% |
| | Other | 0.60% | 66% | 0.37% | 97% |
| CT Foam | | 0.70% | | 0.21% | |
| Defects | | | | | |
| | Root Cause | Defect | % of | Defect | % of |
| | Breakdown | Rate (%) | CT Foam | Rate (%) | CT Foam |
| | | | Defects | | Defects |
| | No visible root | 0.27% | 39% | 0.13% | 62% |
| | cause | | | | |
| | Material Defects | 0.39% | 55% | 0.06% | 27% |
| | Other | 0.42% | 6% | 0.03% | 11% |

CT Foam = charge transfer layer.

As is evident from Table 4 above, electrophotoconductive tubes prepared by the invention gas-slip method have substantially less material defects than those prepared by conventional casting. The defect rate achieved in optical photoconductor drums containing the invention electrophotoconductive tubes is less than half the defect rate achievable in optical photoconductors prepared from electrophotoconductive tubes prepared by conventional casting techniques. Therefore the gas-slip method is able to provide a drawn aluminum tube having a superior surface finish in comparison to the surface of drawn aluminum tubes prepared by conventional (hot-top) casting methods.

Additional invention electrophotoconductive tubes were prepared and examined for defects and performance characteristics. Table 5 provides the results of testing on a series of lots of electrophotoconductive tubes prepared by the invention gas-slip process. As is evident from the information presented in Table 5, the invention electrophotoconductive tubes are able to reliably provide improved defect rates as shown by visual inspection of the optical photoconductor drum and inspection of the anodized tube.

TABLE 5
Gas Slip Cast Uniformity Testing

| | | | | | |
|---|---|---|---|---|---|
| Test Lot # | 1 | 2 | 3 | 4 | 5 |
| Cast Log # | A | B | C | D | E |
| Quantity | 575 | 612 | 594 | 600 | 306 |
| Product | M | M | M | M | M |
| Print Test (Q = 5) | 100% | 100% | 100% | 100% | 100% |
| | Perfect | Perfect | Perfect | Perfect | Perfect |
| Electrical Tests | Scanner: all | Scanner: all | Scanner: all | Scanner: all | Scanner: all |
| (Q = 2) | values within | values within | values within | values within | values within |
| | specification | specification | specification | specification | specification |
| Visual Inspection | 1.56% | 0.16% | 0.67% Substrate | 1.3% Substrate | 0.98% CT |
| | Substrate | Substrate | 0.16% CT Foam | 4.0% CT Foam | Foam |
| Substrate Defect | 5 - handling | 1 - process | Handling | 7 - handling | n/a |
| Root Cause | 3 - material | | | 1 - process | |
| | (featherlines- do | | | | |
| | not print) | | | | |
| | 1 - process | | | | |
| CT Foam Defect | n/a | n/a | 1 - WL | 8 - WL lamination | 2 - WL |
| Root Cause | | | lamination | 15 - laminations | lamination |
| | | | | 1 - no vis. root cause | 1 - lamination |
| Anodized Tube | Grain size is small | Grain size is | Grain size is small | Grain size is small | Grain size is |
| Inspection | with uniform | small with | with uniform | with uniform | small with |
| | distribution. Some | uniform | distribution; a few | distribution; some | uniform |
| | featherlines and | distribution; | featherlines; some | visible weldlines; no | distribution; |
| | weldlines - | some visible | visible weldlines | other material defects | some faintly |
| | intensity and | weldlines; | (Q = ˜160) | (Q = 168) | visible |
| | frequency: low. | no other | | | weldlines; no |
| | (Q = 155) | material | | | other material |
| | | defects (Q = | | | defects |
| | | 171) | | | (Q = 90) |
| Comments | | | 1) CT Foam | 1) CT Foam | 1) CT Foam |
| | | | laminations are ˜50 | laminations are ˜50 | laminations are |
| | | | to 60 um | to 60 um | ˜50 to 60 um |

| | | | | | |
|---|---|---|---|---|---|
| Test Lot # | 6 | 7 | 8 | 9 | 10 |
| Cast Log # | F | G | H | I | J |
| Quantity | 305 | 230 | 307 | 131 | 864 |
| Product | M | M | M | M | M |
| Print Test | 100% | 100% | 100% | 100% | 97% perfect (no |
| (Q = 5) | Perfect | Perfect | Perfect | Perfect | substrate defects) |
| Electrical | Scanner: all | Scanner: all | Scanner: all | Scanner: all | Scanner: all |
| Tests (Q = 2) | values within | values within | values within | values within | values within |
| | specification | specification | specification | specification | specification |
| Visual | 1.31% | 3.9% Substrate | 0.65% | 1.5% | 0.92% |
| Inspection | Substrate | 0.4% CT Foam | Substrate | Substrate | Substrate |
| Substrate | Handling | Handling | Handling | Handling | 4 - handling (pre- |
| Defect Root | | | | | anodize) |
| Cause | | | | | 4 - material (2 - |
| | | | | | featherlines/2- |
| | | | | | lamination) |
| CT Foam | n/a | 1 - no visible root | n/a | n/a | 1 - lamination |
| Defect Root | | cause (very small <100 um) | | | |
| Cause | | | | | |
| Anodized | Grain size is small | Grain size is small | Grain size is | n/a | Grain size is small |
| Tube | with uniform | with uniform | small with | | and uniform |
| Inspection | distribution; some | distribuution; no | uniform | | distrution; some |
| | visible weldlines; | material defects | distribution; | | visible weldlines; no |
| | no other material | (Q = 14) | many | | other material defects |
| | defects | | featherlines; | | (Q = 216) |
| | (Q = 90) | | weldlines | | |
| | | | faintly | | |
| | | | visible | | |
| | | | (Q = 90) | | |
| Comments | | | | | |

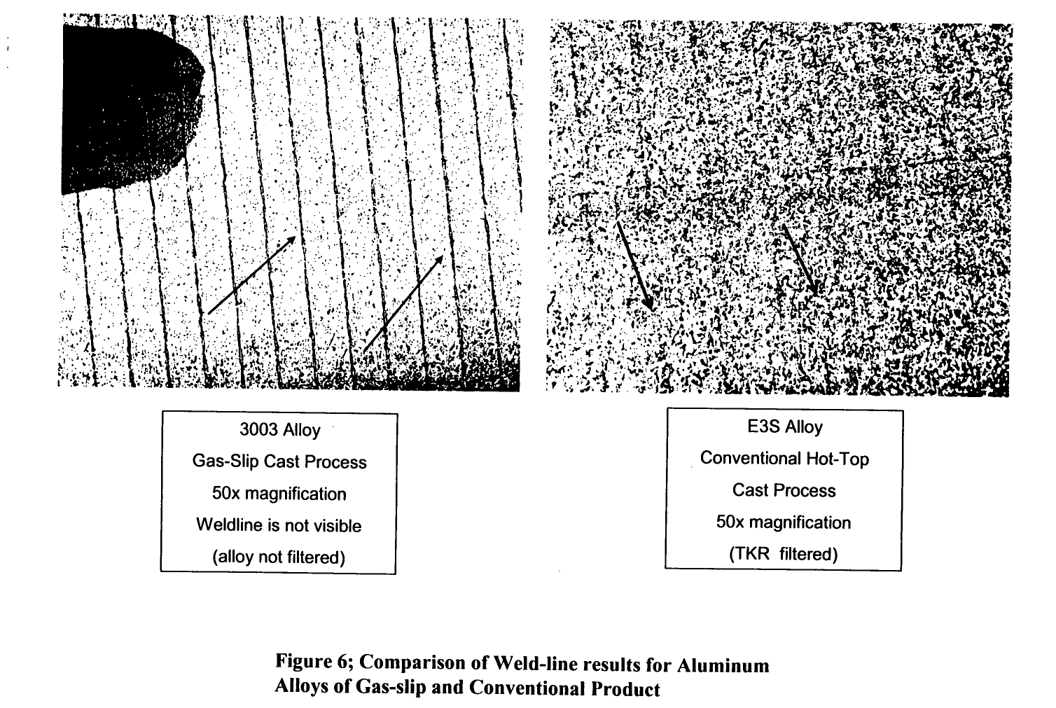

The invention electrophotoconductive tubes are compared with electrophotoconductive tubes prepared by conventional casting methods in FIGS. 5-9. FIG. 6 provides a comparison of the weldline defect in invention and conventional electrophotoconductive tubes. Anodized and turned tubes prepared by the gas-slip method and conventional methods are compared. While a weld line is immediately evident in the photograph of the tube prepared by conventional hot-top casting, no such weldline is evident in the invention electrophotoconductive tube. FIG. 5 further demonstrates the absence of a weldline in the invention electrophotoconductive tube. No weld line is visible in the invention electrophotoconductive tube whereas the conventionally produced electrophotoconductive tube has a visible weldline.

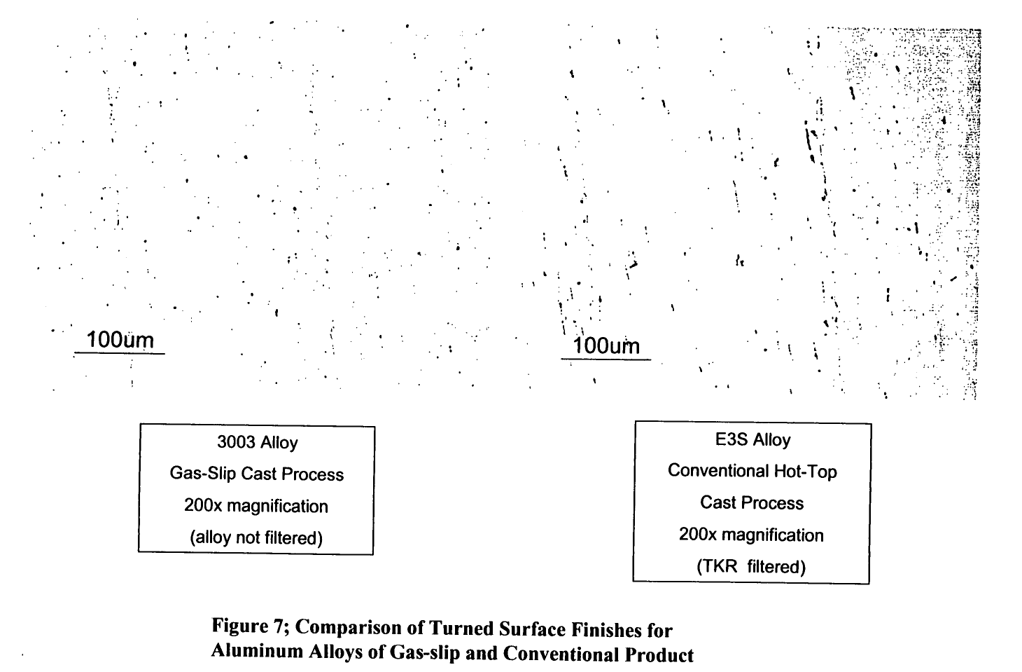

FIG. 7 provides photographs comparing the surface finish of the invention and the conventional electrophotoconductive tubes. The invention electrophotoconductive tube shows less pitting and surface defects in comparison to the conventional electrophotoconductive tube.

The improved surface grain achievable with the invention electrophotoconductive tube may be seen visually at high magnification of the surface of the invention electrophotoconductive tube. Comparative photographs of the invention and comparative electrophotoconductive tubes are provided as FIG. 8. As is evident from the figure, the invention electrophotoconductive tube has a larger surface grain whereas the conventionally produced electrophotoconductive tube has a higher number of surface grains of relatively smaller size.

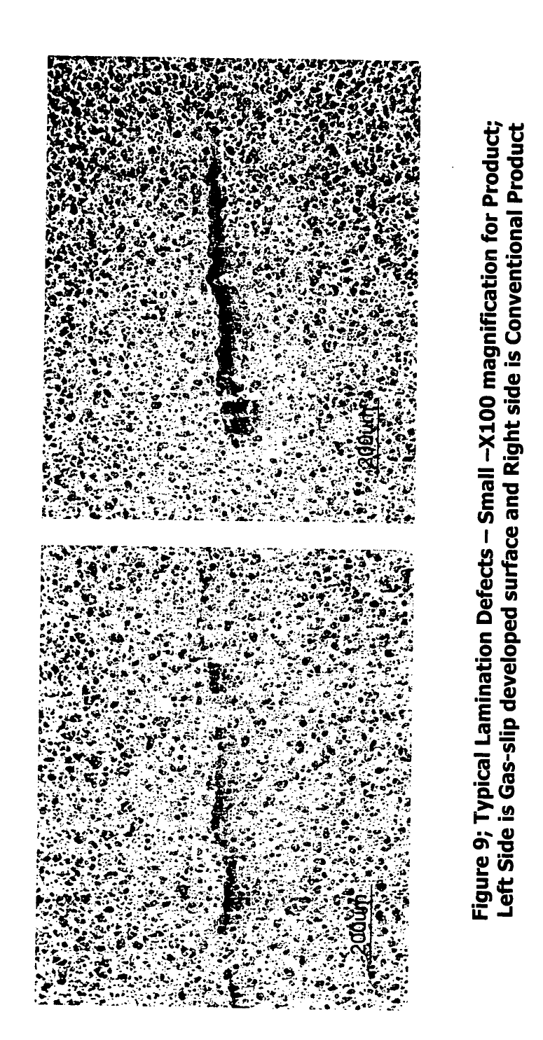

At high magnification, lamination defects on the surface of the optical photoconductor drum may become apparent. Lamination defects for the invention electrophotoconductive tube are of lesser surface area and of lesser magnitude than those present on the conventionally produced electrophotoconductive tube (see FIG. 9).

Major differences in the product obtained conventionally and the subject of the present invention are shown in FIGS. 5-9. It is important to note that an unfiltered 3003 aluminum alloy tube produced with the gas-slip technique yielded better results than a filtered E3S aluminum alloy tube derived from the conventional process. Filtering is time consuming and costly and the possibility of reducing or eliminating filtering to product the finished product offers another advantage over the conventional technique.

Obviously, numerous modifications and variations of the present invention are possible in light of the above teachings. It is therefore to be understood that within the scope of the appended claims, the invention may be practiced otherwise than as specifically described herein.

1. An aluminum electrophotoconductive tube obtained by gas-slip casting of an aluminum alloy.

2. The tube of claim 1, wherein gas-slip casting includes forming a billet and at least one of extruding or drawing the billet to form the tube.

3. The tube of claim 1, wherein the total number of substrate defects of an optical photoconductor drum obtained by coating the tube with a photogeneration layer and a charge transport layer is less than 0.5% based on a visual inspection of the optical photoconductor drum.

4. The tube of claim 1, wherein the aluminum alloy is a 3000 aluminum alloy series.

5. The tube of claim 1, wherein the aluminum alloy is a 6000 aluminum alloy series.

6. The tube of claim 1, wherein the aluminum alloy is an E3S or A40 aluminum alloy.

7. The tube of claim 1, wherein gas-slip casting is carried out without filtering.

8. The tube of claim 1, wherein the aluminum alloy further comprises a grain refiner.

9. The tube of claim 1, wherein the aluminum alloy further comprises titanium boride.

10. The tube of claim 1, having an H₂ porosity of 0.2 ml/100 grams or less.

11. The tube of claim 1, wherein the surface of the tube is substantially free of a weld line visible by the naked eye or by optical microscopy.

12. The tube of claim 1, wherein the tube comprises an aluminum alloy comprising one or more of a recycled aluminum alloy, a regrind from an aluminum recycler, or scrap aluminum from a gas-slip process.

13. The tube of claim 1, wherein the gas-slip casting is carried out with an apparatus for continuous or semi-continuous casting of aluminum having an outlet structure oriented to emit a cooling fluid skirt projecting in a direction parallel to an internal peripheral surface of a die to form a gas cushion between the skirt of the cooling fluid and a peripheral surface of said solidified aluminum tube to form an aluminum tube.

14. The tube of claim 13, wherein the surface of the tube is substantially free of a weld line visible by the naked eye or by optical microscopy.

15. The tube of claim 13, wherein the total number of substrate defects of an optical photoconductor drum obtained by coating the tube with a photogeneration layer and a charge transport layer is less than 0.5% based on a visual inspection of the optical photoconductor drum.

16. The tube of claim 13, wherein the aluminum alloy is a 3000 aluminum alloy series.

17. The tube of claim 13, wherein the aluminum alloy is a 6000 aluminum alloy series.

18. The tube of claim 13, wherein the aluminum alloy is an E3S or an A40 aluminum alloy.

19. The tube of claim 13, wherein gas-slip casting is carried out without filtering.

20. The tube of claim 13, wherein the aluminum alloy further comprises a grain refiner.

21. The tube of claim 13, wherein the aluminum alloy further comprises a titanium boride.

22. The tube of claim 13, having a H₂ porosity of 0.2 ml/100 grams or less.

23. The tube of claim 13, wherein the surface of the tube is substantially free of a weld line visible by the naked eye or by optical microscopy.

24. An optical photoconductor drum comprising
the electrophotoconductive tube of claim 1,
at least one charge generation layer, and
at least one charge transport layer;
wherein the charge generation and charge transport layers are present on the external surface of the electrophotoconductive tube.

25. The optical photoconductor drum of claim 24, further comprising an undercoat layer under the charge generation and charge transport layers.

26. The optical photoconductor drum of claim 24, wherein the electrophotoconductive tube is anodized.

27. The optical photoconductor drum of claim 24, wherein the surface of the tube is substantially free of a weld line visible by the naked eye or by optical microscopy.

28. The optical photoconductor drum of claim 24, wherein the aluminum alloy is a 3000 aluminum alloy series.

29. The optical photoconductor drum of claim 24, wherein the aluminum alloy is a 6000 aluminum alloy series.

30. The optical photoconductor drum of claim 24, wherein the aluminum alloy is an E3S or an A40 aluminum alloy.

31. The optical photoconductor drum of claim 24, wherein gas-slip casting is carried out without filtering the aluminum alloy.

32. The optical photoconductor drum of claim 24, wherein the aluminum further comprises a grain refiner.

33. The optical photoconductor drum of claim 24, wherein the aluminum further comprises a titanium boride.

34. The optical photoconductor drum of claim 24, wherein the tube comprises an aluminum alloy comprising one or more of a recycled aluminum alloy, a regrind from an aluminum recycler, or scrap aluminum from a gas-slip process.
